(19) United States
(12) Patent Application Publication
(10) Pub. No.: US 2004/0078832 A1
(43) Pub. Date: Apr. 22, 2004

(54) Display media real-time rebroadcasting network system and its rebroadcasting method

(75) Inventor: Ming-Hsiang Yang, Taoyuan Hsien (TW)

Correspondence Address: BACON & THOMAS, PLLC, 625 SLATERS LANE, FOURTH FLOOR, ALEXANDRIA, VA, 22314

(73) Assignee: NEO-LED TECHNOLOGY CO., LTD., TAOYUAN HSIEN (TW)

(21) Appl. No.: 10/455,361

(22) Filed: Jun. 6, 2003

(30) Foreign Application Priority Data
Oct. 22, 2002 (TW) 91124350

(51) Int. Cl. H04N 7/16

(52) U.S. Cl. 725/146; 725/151

(57) ABSTRACT

A display media real-time rebroadcasting network system and its rebroadcasting method in which a plurality of displays are connected to a broadcast center through a communication network, and virtual display players connected between the broadcast center and the displays to drive the displays to broadcast program tapes or scene live individually and/or to rebroadcast same programs and same scene live.

### BACKGROUND OF THE INVENTION

1. Field of the Invention

The present invention relates generally to display media, and more particularly to a display media real-time rebroadcasting network system and its rebroadcasting method.

2. Description of the Related Art

Because of the features of big picture and mass visual dissemination effect, display panels are commonly used as active outdoor advertising media for disseminating public information, news, and commodity price news. For the advantages of small size, multi-color, high brilliance, long service life and power saving, a LED (light emitting diode) display panel is most suitable for use as an electronic advertising display panel.

Due to expensive cost and big size, a LED full-color display panel is used for broadcasting independently. It requires much labor to control multiple LED full-color display panels at different display spots. Further, this individual display panel broadcasting method has little advertising value. Therefore, it is desirable to have a display media real-time rebroadcasting network system that enables multiple displays to broadcast different programs or different scene lives, or to form a rebroadcasting network to rebroadcast a same program or scene live, achieving a cost-effective advertising effect.

### SUMMARY OF THE INVENTION

It is the main object of the present invention to provide a display media real-time rebroadcasting network system and its rebroadcasting method, which enables multiple display media to broadcast programs independently, to form local rebroadcasting groups for rebroadcasting programs separately, or to form a rebroadcasting union for rebroadcasting programs all together.

It is another object of the present invention to provide a display media real-time rebroadcasting network system and its rebroadcasting method, which controls multiple displays to broadcast programs automatically by means of a respective virtual player.

It is still another object of the present invention to provide a display media real-time rebroadcasting network system and its rebroadcasting method, which uses wireless transmission technology to achieve a real-time broadcast monitoring control.

It is still another object of the present invention to provide a display media real-time rebroadcasting network system and its rebroadcasting method, which can be set to automatically retrieve program data for broadcasting programs subject to a predetermined program broadcasting schedule.

To achieve these and other objects of the present invention, the display media real-time rebroadcasting network system comprises a broadcast center adapted to classify program tapes provided by clients, and input classified program tapes into a host computer thereof for enabling the host computer to output a broadcasting flow; a plurality of displays connected to the broadcast center through a communication network; and a control interface connected between the broadcast center and the displays and adapted to control the displays to broadcast programs individually or to rebroadcast programs subject to the broadcasting flow provided by the host computer.

### BRIEF DESCRIPTION OF THE DRAWINGS

FIG. 1 is a system block diagram of the present invention; and

FIG. 2 is an operational flow chart of the present invention.

### DETAILED DESCRIPTION OF THE INVENTION

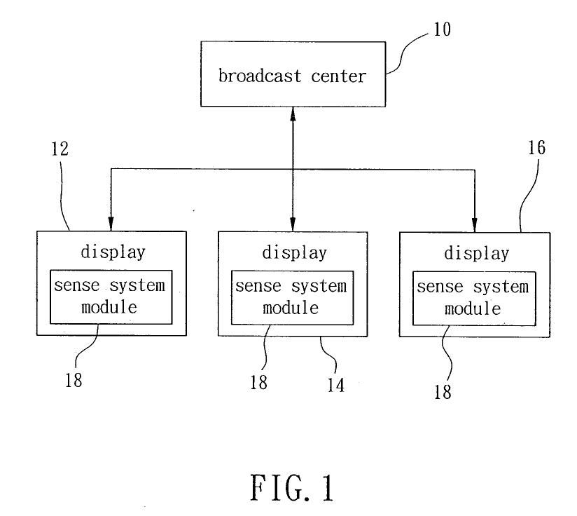

As shown in FIG. 1, the present invention provides an intelligent dynamic display medium real-time rebroadcasting network system, which comprises a broadcast center 10 adapted to input program tapes provided by clients into the host computer of a control center subject to a predetermined classification for enabling the host computer to output a broadcasting flow, three displays 12, 14, and 16 connected to the broadcast center 10 through a communication network, which can be the Internet, a LAN (local area network), or a wireless transmission network, and a control interface (not shown) adapted to serve as a virtual display player, which comprises an electronic hardware and a software. The control interface is connected to the broadcast center 10 and every one of the displays 12, 14, and 16, and controls the displays 12, 14, and 16 to run individual broadcasting or group broadcasting, and to achieve every requirement on broadcasting management. The control interface has auto-reset and overdue file auto-delete functions.

The displays 12, 14, and 16 can be LED (light emitting diode) type displays, LCDs (liquid crystal displays), PDPs (plasma display panels), OLEDs (organic electro-luminescence displays), or CRT (cathode ray tube) monitors, each comprising a sense system module 18. The sense system module 18 comprises a visual module and an audio module for receiving visual signal and audio signal and transmitting received signals to the broadcast center 10. The visual module is an image sensor that can be a CCD (charge coupled device) or CMOS (complementary metal oxide semiconductor), the audio module is a microphone.

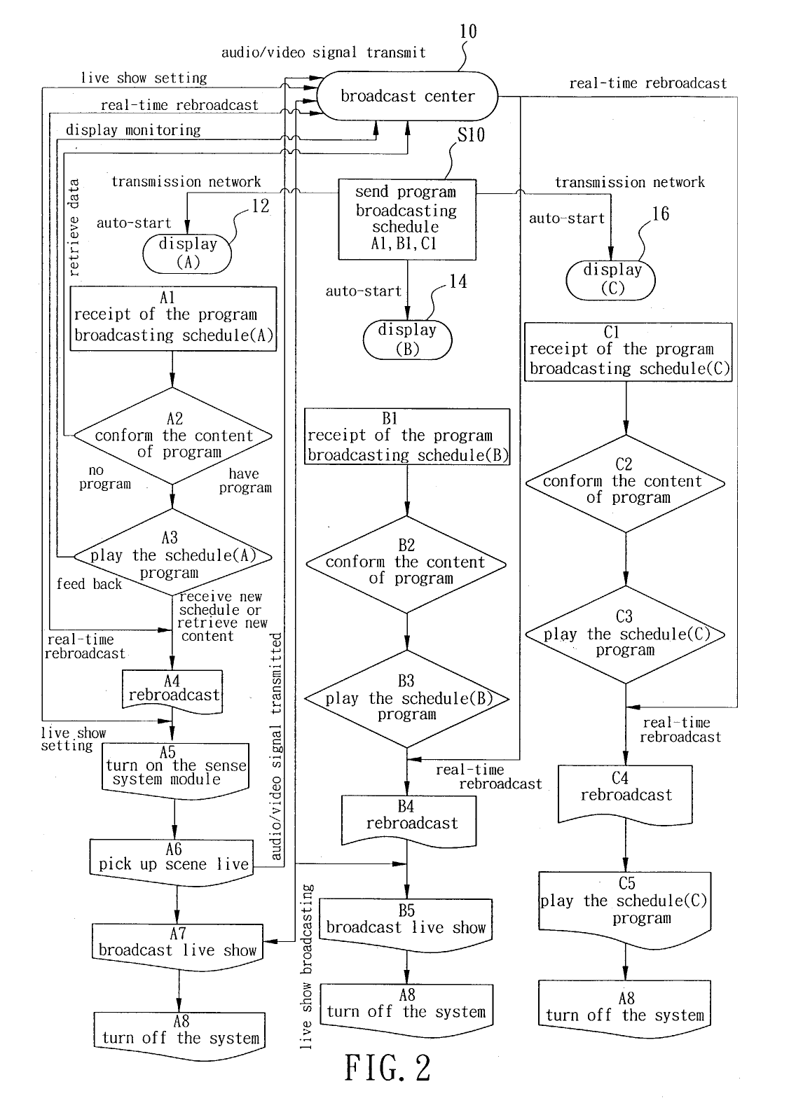

FIG. 2 shows the broadcasting flow of the intelligent dynamic display medium real-time rebroadcasting network system. This huge system contains software and hardware facilities and a complete broadcasting flow to achieve the desired effect. The broadcast center 10 classifies program tapes made by clients, and inputs the classified program tapes into the host computer. Subject to a preset management software, the virtual display players of the displays 12, 14, and 16 retrieve data from the host computer, said displays 12, 14, and 16 (A, B, and C) and virtual display player are operated by daily broadcast schedule and start according the time controlled by the broadcast center 10.

When started (see step S10), the broadcast center 10 sends respective program broadcasting schedules to the virtual display players of the displays 12, 14, and 16 through a cabled or wireless transmission network. Thereafter, it proceeds to the flows A1, B1, and C1. After receipt of the respective program broadcasting schedule, the virtual display player conforms the content of programs of the respective program broadcasting schedule (step A2; B2; C2). If the content of the program broadcasting schedule is the content of the programs stored in the memory of the display 12, 14, or 16, the program broadcasting schedule is followed and broadcasted; if the memory of the display 12, 14, or 16 does not have such program content stored therein, the respective virtual display player automatically retrieves data from the broadcast center 10, and then puts the retrieved data into the respective program broadcasting schedule, and then plays the program subject to the respective program broadcasting schedule; at this time the virtual display player of each display feeds broadcasting message and display function status back to the broadcast center 10 while playing the program, so that the broadcast center 10 can indicate the broadcasting status to ensure broadcasting quality and, the virtual display player of each display can receive a new program broadcasting schedule from the broadcast center 10 and retrieve new program content for broadcasting in the next time slot.

Thereafter, the broadcast center 10 can control the displays 12, 14 and 16 to rebroadcast News or special messages (step A4; B4; C4). If there is a live show in front of one specific display 12, the display 12 can turn on the sense system module 18 (step A5) to pick up the scene live (step A6). The audio and video signals recorded from the scene live by the sense system module 18 are transmitted to the broadcast center 10, which in turn transmit the signals to the desired displays for field pickup rebroadcasting (step A7 and step B5). Thus, the live show at one particular spot has become a national rebroadcasting live show. At this time, the display not included in the scene live rebroadcasting keeps broadcasting the scheduled program (step C5). When the broadcasting of the set program finished, the virtual display player of the display 12, 14, or 16 turns off the system as scheduled (step A8), standing by for starting in the next day to broadcast the programs subject to the program broadcasting schedule received from the broadcast center 10.

The aforesaid displays 12, 14, and 16 are capable of playing multimedia files of a variety of formats including BMP (Bitmap), GIF (Graphic Interchange Format), JPG (Joint Photographic Experts Group), AVI (Audio Video Interleaved), MPG (Moving Picture Experts Group format file), MP3 (Moving Picture Experts Group Layer-3 Audio), WAV (Wave Sound file), and MID (Musical Instrument Digital Interface.

Following is a comparison table showing the superiority of the present invention to the conventional outdoor LED full-color display panels:

| | The Invention | Conventional Design |
|---|---|---|
| Transmission method | Internet data transmission, | Single unit operation, dial- |
| | rapid and cost-effective | up telephone data |
| | | transmission, expensive and |
| | | slow |
| Wireless transmission | Wireless network | Nil |
| | transmission workable | |
| Real-time broadcasting | Multi-station rebroadcasting | Nil |
| | via the Internet | |
| Real-time monitoring | Real-time multi-display | Single display monitoring |
| | monitoring through the | |
| | Internet | |
| Security | Display only receives data | Control center fails when |
| | from control center; signal | telephone line occupied by |
| | encrypted | intruder |
| Control system protection | System shutdown auto-start | Nil |
| Intelligent module block | Module block auto-off | Nil |
| | intelligent LED protection | |
| | upon interruption of control | |
| | signal; auto-start when | |
| | signal resumed | |
| Display module block | Overcurrent and overheat | Nil |
| protection | protection | |
| Maintenance fee | Low | High |
| Field pickup | Yes | Nil |
| Cost | Broadcast center controls | One single display shares |
| | multiple displays, multiple | the all cost |
| | displays share the cost | |
| Cover area | National mass media | Local media |
| Effectiveness of | Local broadcasting and | Only local broadcasting |
| advertisement | rebroadcasting are optional | available |
| Sponsoring commercial cost | Low | High |

As indicated above, the invention provides an intelligent dynamic display media real-time rebroadcasting network, which uses a broadcast center to control multiple displays to broadcast same or different programs or a scene live. The invention combines photoelectric technology, communication technology, and computer information technology, providing a totally new media for the advertising industry.

What is claimed is:

1. A display media real-time rebroadcasting network system comprising:
a broadcast center adapted to classify program tapes provided by clients, and input classified program tapes into a host computer of a control center thereof for enabling the host computer to output a broadcasting flow;
a plurality of displays connected to said broadcast center through a communication network; and
a control interface connected between said broadcast center and said displays and adapted to control said displays to broadcast programs individually or to rebroadcast programs subject to the broadcasting flow provided by said host computer.

2. The display media real-time rebroadcasting network system as claimed in claim 1, wherein said control interface is comprised of an electronic hardware and a software.

3. The display media real-time rebroadcasting network system as claimed in claim 1, wherein said communication network is selected from the group consisting of an Internet, a local area network, and a wireless transmission network.

4. The display media real-time rebroadcasting network system as claimed in claim 1, wherein said displays each is selected from the group consisting of LED (light emitting diode) display panel, LCD (liquid crystal display) display panel, PDP (plasma display panel), OELD (organic electro-luminescence display), and CRT monitor.

5. The display media real-time rebroadcasting network system as claimed in claim 1, wherein said displays each comprises a sense system module formed of a visual module and an audio module for receiving visual signal and audio signal respectively and transmitting received signals to said broadcast center.

6. The display media real-time rebroadcasting network system as claimed in claim 5, wherein said visual module is an image sensor selected from the group consisting of CCD (charge coupled device) and CMOS (complementary metal oxide semiconductor), said audio module is a microphone.

7. The display media real-time rebroadcasting network system as claimed in claim 1, wherein said displays each is adapted to broadcast program files which format is consisting of BMP (Bitmap), GIF (Graphic Interchange Format), JPG (Joint Photographic Experts Group), AVI (Audio Video Interleaved), MPG (Moving Picture Experts Group format file), MP3 (Moving Picture Experts Group Layer-3 Audio), WAV (Wave Sound file), and MID (Musical Instrument Digital Interface).

8. A display media real-time rebroadcasting method comprising the steps of:
providing one broadcast center and a plurality of displays; and
using a communication network to transmit a broadcasting flow to manage said broadcast center and said displays, so as to control said displays to broadcast programs individually or to rebroadcast programs.

9. The display media real-time rebroadcasting method as claimed in claim 8, further comprising a control interface adapted to control said displays to work subject to said broadcasting flow.

10. The display media real-time rebroadcasting method as claimed in claim 9, wherein said control interface comprises an electronic hardware and a software.

11. The display media real-time rebroadcasting method as claimed in claim 8, wherein said communication network is selected from the group consisting of an Internet, a local area network, and a wireless transmission network.

12. The display media real-time rebroadcasting method as claimed in claim 8, wherein said displays each is selected from the group consisting of LED (light emitting diode) display panel, LCD (liquid crystal display) display panel, PDP (plasma display panel), OELD (organic electro-luminescence display), and CRT monitor.

13. The display media real-time rebroadcasting method as claimed in claim 8, wherein said displays each comprises a sense system module formed of a visual module and an audio module for receiving visual signal and audio signal respectively and transmitting received signals to said broadcast center.

14. The display media real-time rebroadcasting method as claimed in claim 13, wherein said visual module is an image sensor selected from the group consisting of CCD (charge coupled device) and CMOS (complementary metal oxide semiconductor), said audio module is a microphone.
